(19) United States
(12) Patent Application Publication
(10) Pub. No.: US 2021/0063603 A1
(43) Pub. Date: Mar. 4, 2021

(54) Distributed computing system and method for generating atmospheric wind forecasts

(71) Applicant: Loon LLC, Mountain View, CA (US)

(72) Inventors: Salvatore Candido, Mountain View, CA (US); Aakanksha Singh, Sunnyvale, CA (US); Luca Delle Monache, San Diego, CA (US)

(21) Appl. No.: 17/001,536

(22) Filed: Aug. 24, 2020

Related U.S. Application Data
(60) Provisional application No. 62/891,893, filed on Aug. 26, 2019.

(51) Int. Cl. G01W 1/10; G06N 3/04; G06N 3/08

(52) U.S. Cl. CPC G01W 1/10; G06N 3/08; G06N 3/0454

(57) ABSTRACT

The technology relates to a distributed computing system and method for generating atmospheric wind forecasts. A distributed computing system for wind forecasting in a region of the atmosphere may include an analog ensemble distilling architecture, a processor, and a memory. The analog ensemble distilling architecture may include a learner configured to train a deep neural network using analog ensemble data and output a distilled analog ensemble capable of producing an improved forecast, a reservoir comprising a cache, a builder comprising a plurality of jobs configured to sample a plurality of slices of an analog ensemble function, and a corpus. The processor may be configured to apply an analog ensemble operator, generate overlapping forecast output files, and generate wind forecasts. The memory may be configured to store one or more components of the analog ensemble distilling architecture.

### CROSS-REFERENCE TO RELATED APPLICATIONS

This application claims the benefit of U.S. Provisional Patent Application No. 62/891,893 entitled “Distributed computing system and method for generating atmospheric wind forecasts,” filed Aug. 26, 2019, the contents of which are hereby incorporated by reference in their entirety.

### BACKGROUND OF INVENTION

Methods exist for forecasting atmospheric winds using machine learning techniques, including algorithms that leverage deep neural networks. In addition, analog-based methods for forecasting winds have been explored for decades (Lorenz, 1969) to develop prediction methods for a range of weather parameters. Analog-based methods compare a current forecast of a region of the atmosphere with a repository of historical forecasts of the region of the atmosphere to determine the most similar scenario in the past—an analog.

Analog ensemble (AnEn) techniques have been applied for the prediction of weather parameters, tropical cyclone intensity, air quality, and renewable energy. In conventional AnEn algorithms, the AnEn constructs a probability distribution of a forecast parameter such as wind speed or heading, given a forecast, previous forecasts made by the same model, and corresponding ground truth for (i.e., observations corresponding to) those previous forecasts. However, finding and verifying analogs in a large corpus of historical data takes a lot of compute resources, and often requires an amount of post-processing time that is not practical for use in an operational system (e.g., planning for a fleet of aerial vehicles in real time).

Thus, a solution for generating more accurate and granular atmospheric wind forecasts in an operational time frame is desirable.

### BRIEF SUMMARY

The present disclosure provides for techniques relating to a distributed computing system and method for generating atmospheric wind forecasts. A distributed computing system for wind forecasting in a region of the atmosphere may include an analog ensemble distilling architecture comprising: a learner configured to train a deep neural network using analog ensemble data and output a distilled analog ensemble, a reservoir comprising a cache, a builder comprising a plurality of jobs configured to sample a plurality of slices of an analog ensemble function, a corpus; a processor configured to: apply an analog ensemble operator, generate overlapping forecast output files, and generate wind forecasts; and a memory configured to store one or more components of the analog ensemble distilling architecture, wherein the distilled analog ensemble is configured to output an improved wind forecast. In some examples, the system also includes a metalearner configured to vary a learning parameter. In some examples, the learning parameter comprises a learning rate. In some examples, the learning parameter comprises a batch size. In some examples, the cache is an in-memory cache. In some examples, the cache is distributed over a plurality of jobs. In some examples, the corpus comprises a plurality of key-value pairs pairing a forecast with a ground truth observation. In some examples, each of the plurality of key-value pairs indicates a latitude and a longitude. In some examples, each of the plurality of key-value pairs indicates an altitude. In some examples, each of the plurality of key-value pairs indicates a lead time. In some examples, the improved wind forecast is deterministic. In some examples, the improved wind forecast is probabilistic. In some examples, the probabilistic improved wind forecast comprises a quantification of the ensemble mean uncertainty.

A method for distilling an analog ensemble may include receiving weather forecast data and weather observation data for a region of the atmosphere; generating, by a distributed computing system, a corpus comprising a forecast-observation key-value pair for each point on a grid map, each point indication a location on the grid map; generating an in-memory cache comprising an evolving plurality of training examples, each training example comprising a slice of an analog ensemble; training a deep neural network using the evolving plurality of training examples; and outputting a distilled analog ensemble. In some examples, the method also includes saving the corpus as a data file. In some examples, generating the corpus comprises generating a set of forecast outputs comprising a plurality of forecast outputs that are overlapping in time, the set of forecast outputs based on the weather forecast data. In some examples, the corpus represents historical forecast and observation data spanning at least two years.

A method for generating an improved wind forecast in a region of the atmosphere may include receiving a forecast comprising a wind vector for a plurality of grid points on a grid map; applying a distilled analog ensemble at all grid points of the forecast; and outputting an improved forecast. In some examples, the distilled analog ensemble uses inputs of one, or a combination of two or more, of a latitude, a longitude, a pressure, and a lead time. In some examples, the improved forecast has a lower error rate than the forecast. In some examples, the improved forecast provides an uncertainty quantification.

### BRIEF DESCRIPTION OF THE DRAWINGS

Various non-limiting and non-exhaustive aspects and features of the present disclosure are described hereinbelow with references to the drawings, wherein:

FIG. 1 is a flow diagram illustrating a method for generating and updating a corpus of examples at scale, in accordance with one or more embodiments.

FIG. 2A-B are flow diagrams illustrating methods for distilling an analog ensemble function into a deep neural network, in accordance with one or more embodiments.

FIGS. 3A-B are flow diagrams illustrating methods for producing an improved wind forecast in an operational time frame, in accordance with one or more embodiments.

FIG. 4 is a simplified block diagram of an exemplary infrastructure for distilling an AnEn, in accordance with one or more embodiments.

FIG. 5 is a graph illustrating a set of overlapping forecast output files over time, in accordance with one or more embodiments;

FIG. 6A is a plot showing an example output of a function mapping wind speed and direction of weather data to an analog ensemble mean, in accordance with one or more embodiments;

FIG. 6B is a series of top down views of variations in the plot in FIG. 6A, with and without post-processing, in accordance with one or more embodiments;

FIG. 7A is a simplified block diagram of an exemplary computing device in a distributed computing system, in accordance with one or more embodiments.

FIG. 7B is a simplified block diagram of an exemplary distributed computing system suitable for performing the methods described herein, in accordance with one or more embodiments; and

FIG. 8 is schematic diagrams of an exemplary operational system in which wind forecasting methods may be implemented, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driving vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to a distributed computing system and efficient, scalable method for generating accurate atmospheric wind forecasts. Forecasts of weather, winds, and other forecasts (e.g., of stochastic phenomena) in one or more regions, layers, or sub-layers (collectively “regions”) of the atmosphere (e.g., surface, troposphere, lower stratosphere, stratosphere, mesosophere, etc.) may be improved using machine learning to post-process forecast outputs (e.g., numerical weather model outputs (i.e., weather forecast data), and other forecast model outputs). An analog ensemble (AnEn) algorithm may be applied to forecast data (e.g., weather forecast data), including partitioning the forecast data and executing an independent computation for each grid point and forecast lead time using analogs comprising ground truth data (e.g., weather observation data including wind data, or other historical data against which forecast data may be compared). The post-processing of the forecast data using the AnEn algorithm and analogs may produce a more granular and accurate wind forecast (e.g., a reduction of forecast error) and a quantification of uncertainty (e.g., turning a single forecast into an ensemble forecast with appropriate probability distribution characteristics).

To perform the AnEn algorithm on a global scale, the computations may be performed over a distributed computing system (e.g., across many datacenter computers, and even across tens, hundreds, and thousands, of datacenters), wherein a 3D forecast with a plurality of pressure levels (i.e., corresponding to a plurality of altitudes) over a plurality of lead times may be generated in a matter of minutes (e.g., 10-20 minutes, or more or less). In examples described herein, atmospheric pressure may be a proxy for altitude. Such a 3D forecast may be provided at a variety of resolutions (i.e., increments).

An AnEn may be distilled (i.e., memorized or learned) into a deep neural network (DNN) to approximate the application of the AnEn algorithm point-wise, enabling using a new, larger corpus of analogs (e.g., up to and beyond 100s of terabytes of data) to create the distilled AnEn, which effectively enables a larger corpus of forecasts and may improve the AnEn quality without using additional computation and or time in the critical path (i.e., post-processing a forecast) of an operational system, such as a fleet management and/or flight planning system for a fleet of aerial vehicles. This makes the AnEn technique feasible in real operational systems. A DNN may be trained to learn a function mapping wind speed and direction from a current forecast to analogs (e.g., analog ensemble mean, ensemble forecasts). A response curve of an AnEn may be plotted to visualize the effect of the AnEn. Once a DNN is trained, it can be applied to any point (e.g., a place and time) in the weather data.

Analog ensemble algorithms may be used to improve output of existing weather data models (e.g., National Oceanic and Atmospheric Administration's (NOAA's) Global Forecast System (GFS) and the European Center for Medium-Range Weather Forecast's (ECMWF's) high resolution forecasts (HRES)). Using techniques described herein, aggregated forecast error may be reduced significantly (e.g., a range of 2%-11% on stratospheric wind speed and 10%-20% on heading), with improvements growing as lead times increase. Using a distributed system to generate AnEn output for a global forecast based on a few years (e.g., ranging from approximately one to five years) of forecast and weather observation data can be achieved by the techniques described herein in a matter of minutes (e.g., ranging from 5-20 minutes, or more or less). Distilling the AnEn into a DNN enables the system to scale at least to (i.e., post-process) a corpus of tens of years of historical forecasts, which can significantly improve forecast quality, and output improved wind forecast within an operational time frame (e.g., from a few minutes to a few hours). Distilling the AnEn generates a DNN that can implement a pointwise function that approximates the conventional AnEn algorithm. Thus, when a new forecast is received (e.g., a vector of wind speeds or other fields), the DNN may quickly produce an approximate improved forecast for each grid point, enabling a quick look-up of the improved forecast at any given grid point or other given point (i.e., between grid points) with no added latency. Further, using a longer historical forecast to create the pointwise function does not affect the real time operations of the system.

Post-processing an operational forecast takes place in the critical path of providing new operational data to a consumer system, e.g., a high altitude aerial vehicle's navigation system. New improved forecast data may be generated in the operational model described herein periodically (e.g., every few hours, 10 hours, 12 hours, or more or less frequently) or ad hoc (e.g., as desired, globally or for a desired location or region.

DNNs have a high capacity for encoding complex functions. A distilled AnEn as described herein is preferable to directly training a DNN to improve forecasts due to the relatively low amount of training data available for direct training. The AnEn generalizes well, or at minimum, provides an improved wind forecast according to key metrics when deployed to long validation periods on unseen meteorological forecasts. The distilled AnEn bootstraps training the DNN off the AnEn, effectively combining the AnEn's strength of being able to generate forecasts with a relatively small corpus of training examples with the DNNs ability to memorize this complex function in a much smaller number of parameters.

### Example Methods

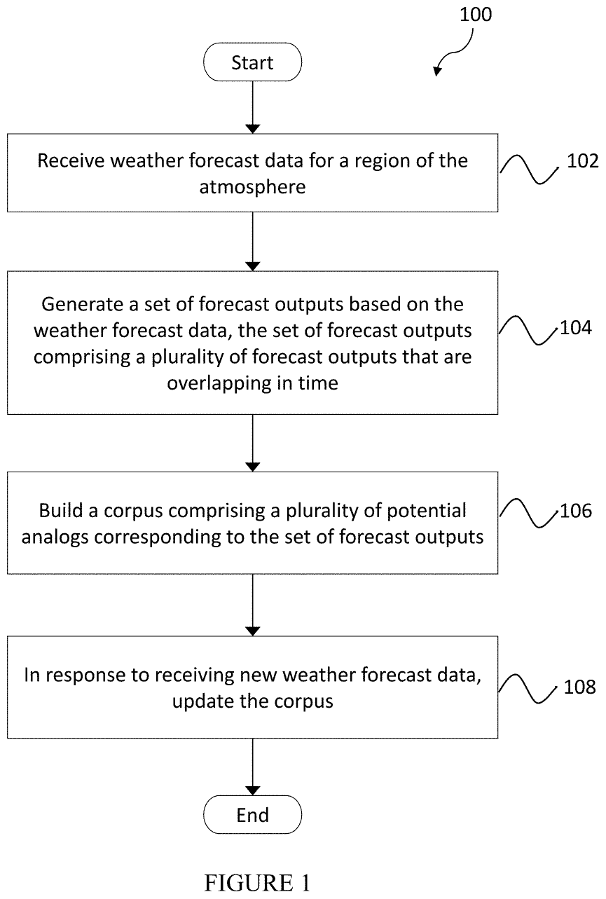

FIG. 1 is a flow diagram illustrating a method for generating and updating a corpus of examples at scale, in accordance with one or more embodiments. Method 100 begins with receiving weather forecast data for a region of the atmosphere at step 102. The weather forecast data may comprise output from existing weather data models (e.g., ECMWF HRES, NOAA GFS, and the like). The weather forecast data received may include global wind forecast data, or wind forecast data for a geographical location of interest (e.g., for a set of latitude-longitude designations, a set of three dimensional map cells), and may include wind forecasts for a plurality of altitudes (e.g., a predetermined range, an operational range, a defined range of altitudes for an atmospheric layer of interest, and other altitude ranges). The weather forecast data may be received from one or more sources, periodically, asynchronously, ad hoc, or according to other cadence.

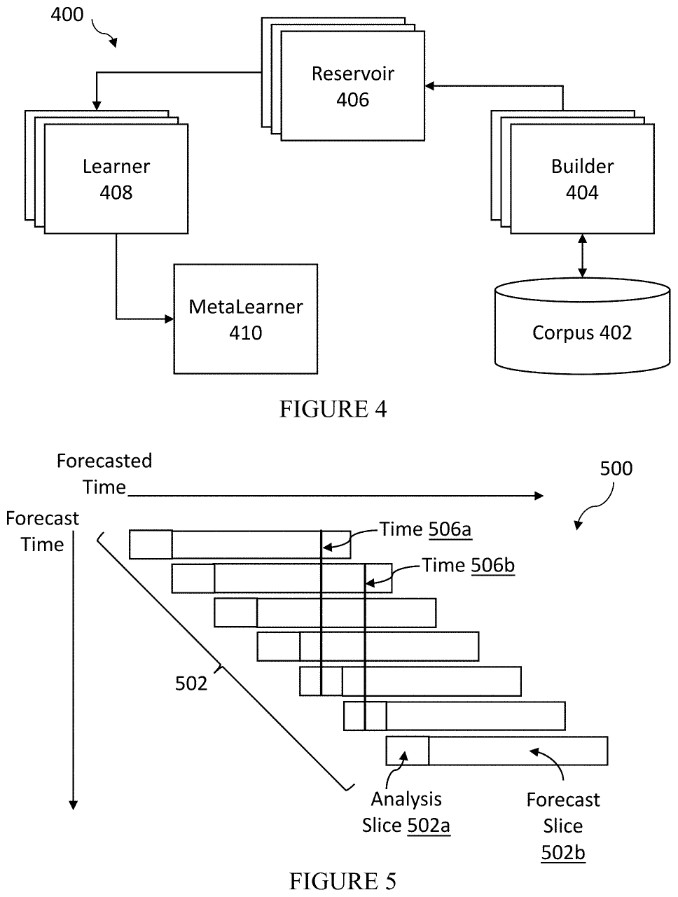

A set of forecast outputs (e.g., output files) based on the weather forecast data may be generated at step 104, each set of forecast outputs comprising a plurality of forecast outputs that are overlapping in time (i.e., the time being forecast). FIG. 5 is a graph illustrating a set of overlapping forecast output files over time, in accordance with one or more embodiments. Graph 500 includes a plurality of forecast output files 502, each comprising an analysis slice 502a and a forecast slice 502b. Each forecast output file corresponds to a latitude, longitude, and forecast time. An analysis slice 502a from a later forecast output file, which may comprise wind observation data, may correspond to a portion of a forecast slice 502b from an earlier forecast output file. Thus, for any given forecasted time 506a-b, a set of forecast data and observational data across the plurality of forecast output files 502 may be associated. For example, the line representing forecasted time 506a, indicates the analysis slice for that forecasted time, and all associated prior forecast slices.

Returning to FIG. 1, a corpus may be built at step 106, the corpus comprising a plurality of potential analogs corresponding to the set of forecast outputs. In the example shown in FIG. 5, observation data in analysis slice 502a may provide such potential analogs. In other examples, ground truth analogs may comprise measurements obtained by other means (e.g., sensors on vehicles, weather stations, satellite, GPS radio occultation, and other sensing techniques). In an example, a corpus of forecast-observation examples (i.e., potential analogs) may be built using a Map-Reduce framework, which allows the computation to run on a distributed computing (cloud) infrastructure (e.g., Google's Flume) and to efficiently process large volumes of data across a pool of datacenter computers. An identity reducer may be used to materialize the data into a key-value storage such as a sharded SSTable, a flat file (e.g., where no key-value lookups are required), or to use it ephemerally to run the AnEn algorithm in a reduce phase. The forecast output files may be unpacked in parallel and then mapped over each <lat, lng, pressure, forecasted time, forecasted speed, forecasted heading> tuple. The map step emits the key-value pair <lat, lng, pressure, forecasted time>→<forecast time, forecasted speed, forecasted heading>. In the reduce phase, every emitted record with the same key is processed together, thereby the key-value pairs may be joined by key in the corpus, along with other data (e.g., optimal weights for matching). In some examples, a Map-Reduce technique may be used to generate a global scale historical forecast corpus. In practice this corpus may be built in advance of receiving a weather forecast to post-process. In some examples, a second iteration of the Map-Reduce technique may be used to group the corpus data by grid point (i.e., any point on a grid map, which may be identified by latitude, longitude, cell, or any other identifier) and run an AnEn algorithm.

Any number of map and reduce phases may be distributed across a large number of machines in a datacenter, as described herein, allowing the Map-Reduce process to run at scale at appropriate operational speeds. In some examples, one may choose to materialize the corpus periodically to not process the raw model files over and over again, but not necessarily generate a new corpus every time a new model output file group comes in. Effectively this is a hybrid approach where the corpus is periodically materialized and models outputs newer than the last corpus are mapped ephemerally into the pipeline until they are included in a corpus.

In response to receiving new weather forecast data, the corpus may be updated at step 108. In an example, when a new forecast model output file is available for processing, the existing data may be mapped over, and for each point a <lat, lng, pressure, lead time>→<forecasted speed, forecasted heading> emitted. This is joined by key with the corpus and also any side data (e.g., optimal weights for matching), which also may be emitted under the appropriate key.

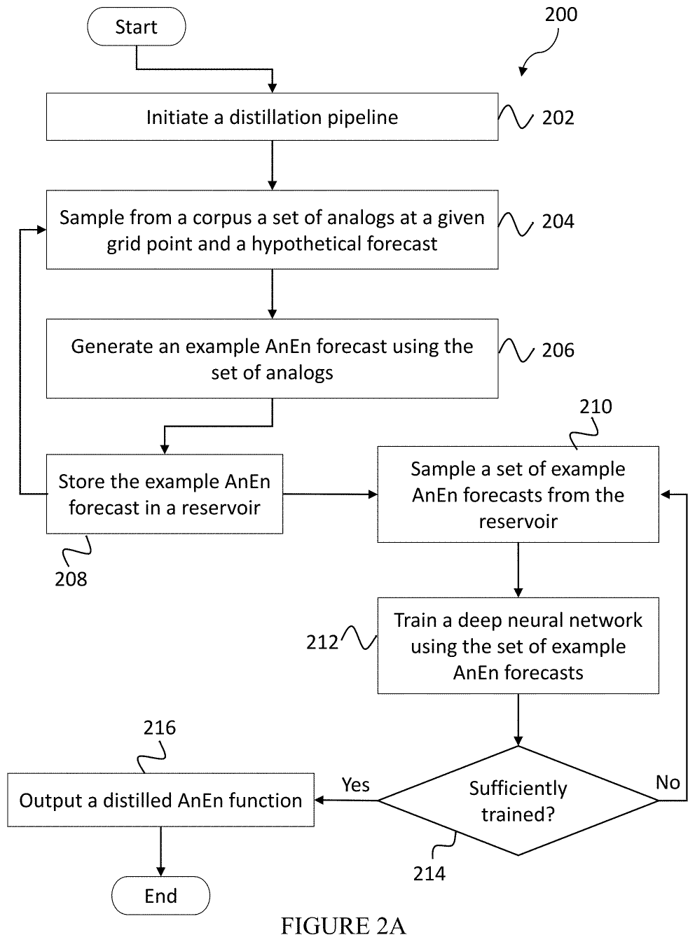

FIGS. 2A-2B are flow diagrams illustrating a method for distilling an AnEn function into a DNN, in accordance with one or more embodiments. Method 200 may begin by initiating a distillation pipeline at step 202. A set of analogs may be sampled from a corpus (e.g., by a builder, as described herein) at a given grid point and a hypothetical forecast at step 204. An example AnEn forecast may be generated using the set of analogs at step 206. The example AnEn forecast may be stored in a reservoir at step 208, for example, at which point another set of analogs may be sampled from the corpus to generate another example AnEn forecast. A set of example AnEn forecasts may be sampled from the reservoir at step 210. A DNN may be trained using the set of example AnEn forecasts at step 212. A determination may be made, at step 214, whether the DNN is sufficiently trained. If not, then the process returns to step 210 and continues the training loop. If it is, a distilled AnEn function may be output at step 216, at which point the loop including steps 204-208 also may cease. As described herein, this process may be performed across a distributed computing system, such that a plurality of sets of analogs and a plurality of sets of example AnEn forecasts may be sampled in parallel.

In FIG. 2A, method 250 begins with receiving weather forecast data and weather observation data for a region of the atmosphere at step 252. A corpus comprising a forecast-observation key-value pair for each point on a three-dimensional or four-dimensional grid map may be generated at step 254, each point indicating a location (e.g., latitude, longitude, altitude) and each key-value pair referenced to a time (e.g., actual time, lead time, other reference time). In some examples, the corpus may be generated by resharding a raw data set (e.g., stored as a raw corpus) into latitude, longitude, pressure altitude, and lead time to forecast-observation key-value pairs. For example, the resharding algorithm may construct <forecast, ground truth> vector pairs, i.e., what the model forecast wind speed and heading to be paired with actual wind speed and heading. An example forecast vector in this pair may be a given speed (i.e., in m/s) and heading (i.e., in degrees from a line of constant latitude on the globe) for wind at a latitude, longitude, and pressure (i.e., in positive or negative degrees, positive or negative degrees, and Pascals or other indication of altitude) as predicted by a weather model (e.g., ECMWF HRES, NOAA GFS) for a given lead time (e.g., 12 hours later, 24 hours later, or more or less) from a given day and time. An example corresponding ground truth vector in this pair is that at the given lead time from the given day and time, the wind at the same latitude, longitude, and pressure, in actuality had an observed speed and heading.

The corpus may be saved as a data file (e.g., a shared dataset) at step 256. An in-memory cache (i.e., reservoir) comprising an evolving plurality of training examples may be generated at step 258, each training example comprising a slice of an AnEn comprising a sample wind speed and heading. A cohort of builder jobs may sample slices of an AnEn function indicating a sample wind speed and wind heading forecast for each latitude, longitude, pressure altitude and lead time. In some examples, a slowly changing reservoir of training examples may utilize a large distributed buffer that is slowly updated over time. A cadre of worker tasks may load and/or replace (i.e., update) the in-memory cache with additional training examples periodically, randomly, or according to other cadences. For example, new training examples may be added to a reservoir, randomly replacing older data in the reservoir (e.g., in a buffer). Using the rate at which we add new data and overall capacity of a buffer, we can control dwell time distribution and diversity of samples. A similar technique to a replay buffer in deep reinforcement learning may be utilized, wherein a slowly changing flow of examples is provided, and each batch (i.e., on average) tends to draw from disparate parts of the function mapping being learned.

The evolving plurality of training examples may be used to train (e.g., be memorized or learned by) a DNN at step 260, for example using a learner, as described herein. A DNN training procedure may be implemented, pulling random batches of training examples from a reservoir. The learner may output a distilled AnEn at step 262.

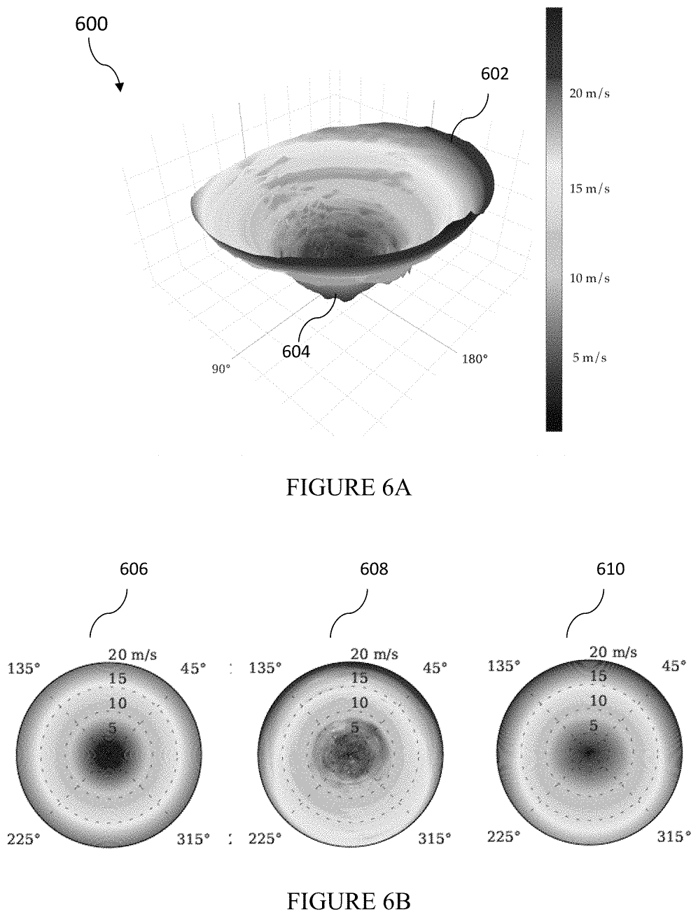

In some examples, the improved wind forecast output by a distilled AnEn may be visualized with a three-dimensional plot, as shown in FIG. 6A, plotting the (input) wind speed forecast as distance from the origin, (input) wind heading forecast as angle from the x-axis, and (output) wind speed forecast on the z-axis. FIG. 6A is a plot showing an example output of a function mapping wind speed and direction of weather data to an analog ensemble mean, in accordance with one or more embodiments. Plot 600 shows a roughly cone-shaped output associated with a place and lead time. In particular, it shows mapping a forecast x^{f} to AnEn mean. With a distilled AnEn, the result given any x^{f} can be generated prior to receiving a new forecast, and a distilled AnEn in a 100 kb data file may achieve an improved wind forecast quality similar to that of a typical AnEn function represented with a data corpus of one or more terabytes.

The shape of this cone may change over different lead times and places around the world and encodes the transformation that is used to generate an, on average, improved wind forecast. A top rim of the cone 602 may correspond to a higher wind speed (e.g., 20 m/s or greater) and a bottom tip of the cone 604 may correspond to a lower wind speed (e.g., 5 m/s or less). FIG. 6B is a series of top down views of variations in the plot in FIG. 6A, with and without post-processing, in accordance with one or more embodiments. View 606 shows the plot with no AnEn post-processing, view 608 shows the plot with conventional AnEn processing, and view 610 shows the plot as output by a distilled AnEn. Views 608 and 610 may be similar, although exhibit slight differences as the distilled AnEn is able to generalize across multiple sets (D) of observation data. As shown, some deformation from the perfect cone is introduced by an AnEn algorithm h. An equation showing the AnEn algorithm operating on a forecast to derive an AnEn mean may be: y_{bc}=h_{D}(x^{f})

In some examples, every AnEn may be simultaneously approximated by using the tuple that specifies the grid point k as an input parameter y_{distilled}=h(k, x^{f}). In an example, speed mean, direction mean, and the standard deviations of the ensemble forecasts for both quantities may be distilled into a single DNN with multiple outputs.

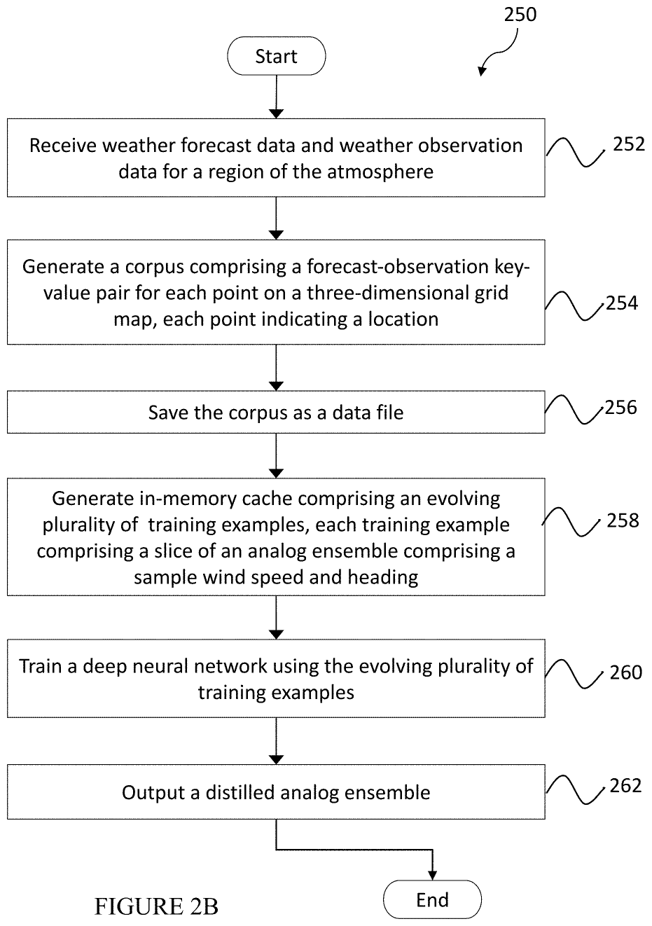

In FIGS. 3A-3B are flow diagrams illustrating methods for producing an improved wind forecast in an operational time frame, in accordance with one or more embodiments. Method 300 may begin with receiving a forecast (e.g., a weather forecast comprising vectors of wind speeds and headings, forecasts comprising other fields, such as barometric pressure, temperature, upwelling IR, precipitation, water vapor) at step 302. A distilled AnEn may be applied to all grid points of the forecast at step 304. A post-processed forecast (i.e., improved forecast) may be output at step 306. Alternatively, in FIG. 3B, method 310 may begin with receiving a forecast at step 312, applying a distilled AnEn on raw data from the forecast (e.g., for a grid point, another point between grid points, or other portion of the forecast data) at step 314, and outputting post-processed forecast data corresponding to a portion (e.g., a grid point, a plurality of grid points, a point between grid points, or other portion) of the forecast at step 316.

The grid map may be three-dimensional (e.g., including a range of altitudes), and may comprise grid point designations by latitude, longitude, pressure, time, uniquely identified stations or infrastructure, or designations in various fields and dimensions. The weather forecast data may comprise wind forecast data for some or all of the grid map. The distilled AnEn may output an improved wind forecast (e.g., including wind speed and heading) at step 306. The distilled AnEn may take inputs of latitude, longitude, pressure (altitude), and time in the future (i.e., lead time), together with a corresponding forecast wind speed and heading. Given this set of parameters it may generate a new forecast of wind speed and heading that has demonstrably higher forecast accuracy (e.g., lower centered root-mean-square error (CRMSE) with continued high correlation) than the original forecast, along with an uncertainty quantification (e.g., an ensemble forecast or probability distribution over the forecast quantity). The distilled AnEn may be represented in a data file of ˜100 kb, providing far more efficiency and flexibility in the operational post-processing critical path. As described herein, once trained, a distilled AnEn uses a fixed computational complexity even as the training corpus grows, which enables implementing a global AnEn with decades of historical forecasts. Output parameters of the distilled AnEn, whether analog means or probability distribution across a variable, may be functions of latitude, longitude, pressure, and lead time, as well as forecast fields (e.g., wind speed and heading).

### Example Systems

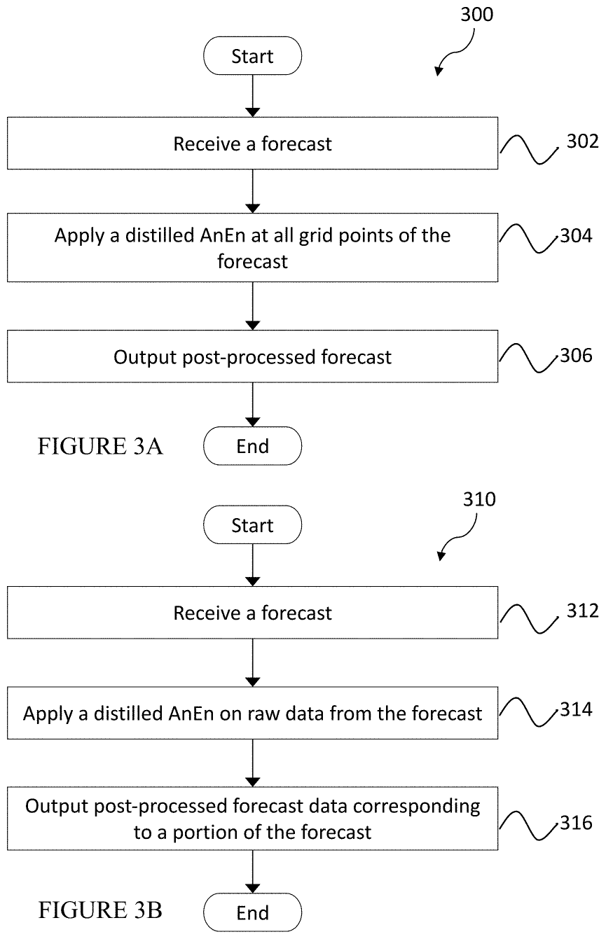

FIG. 4 is a simplified block diagram of an exemplary infrastructure for distilling an AnEn. Diagram 400 includes corpus 402, builder 404, reservoir 406, learner 408 and metalearner 410. Corpus 402 may comprise potential analogs (e.g., forecast, ground truth key-value pairs), and may be generated or built according to the methods described above. The corpus may be saved as a data file, and may provide data to builder 404. Builder 404 may comprise a plurality of builder jobs to sample slices of an AnEn function (i.e., a latitude, longitude, pressure and lead time) to build training examples comprising sample wind speed and heading forecasts for each slice. The training examples may be added to reservoir 406 to update and replace the examples from which learner 408 may pull to train a DNN. Reservoir 406 may be an in-memory cache, or other cache or memory for easy access, and may be distributed, as described herein. Reservoir 406 may comprise a slowly changing distribution of training examples. In some examples, control flow between reservoir 406 and builder 404 may be implemented to maintain a consistent distribution of time across the training examples in reservoir 406. Said distribution of time may be one of various parameters that metalearner 410 may vary to optimize the learning process, along with other parameters (e.g., learning rate, batch size, network architecture).

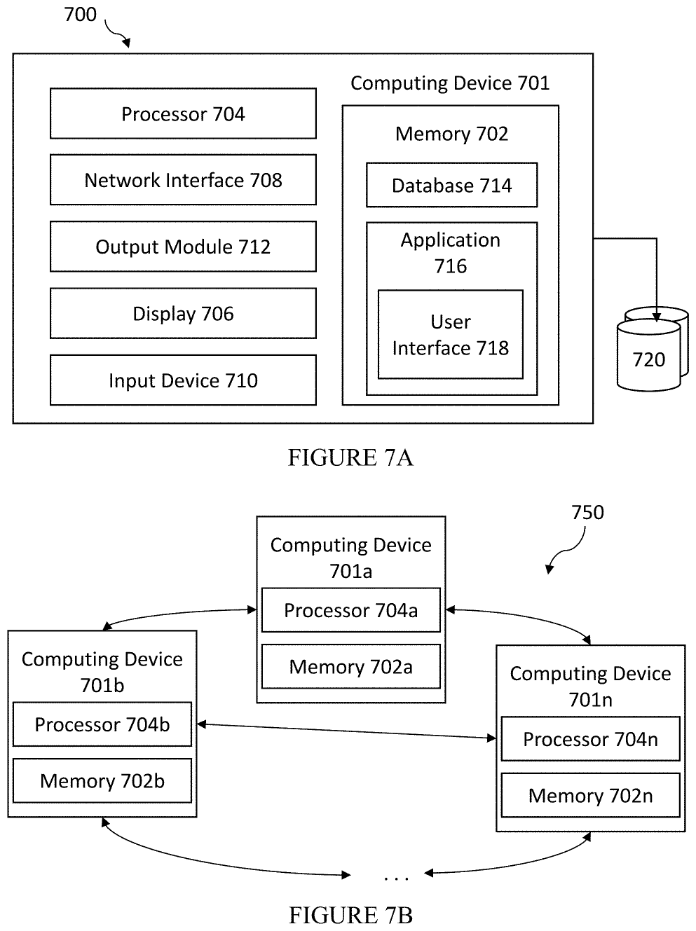

Learner 408 may be configured to train a DNN to develop and output a distilled AnEn using examples from reservoir 406. Learner 408 also may be configured to evaluate the quality of a distilled AnEn (e.g., how well it can improve accuracy of wind forecasts), and to save the resulting distilled AnEn (e.g., in a storage or repository, such as storage 720 in FIG. 7). In some examples, learner 408 may comprise a plurality of learners, all of which may use training examples from a single reservoir 406. In other examples, separate learners may utilize separate reservoirs (not shown).

FIG. 7A is a simplified block diagram of an exemplary computing system in a distributed computing system, in accordance with one or more embodiments. Computing system 700 may include computing device 701 and storage system 720. Computing device 70 includes a memory 702 storing a database 714 and an application 716. Application 716 may include instructions which, when executed by processor 704, may cause computing device 701 to perform various steps and/or functions, as described herein. Application 716 also may include instructions for generating a graphical user interface (GUI) 718 (e.g., configured to enable interactions with the training and/or distilled AnEn systems described herein, and to display outputs and visualizations). Database 714 may store various algorithms and/or data, including AnEn algorithms, distilled AnEn, weather forecast and observations data (e.g., numerical weather models and forecasts, historical weather forecasts, other wind data), past and present locations of aerial vehicles, a reservoir or other components in FIG. 4, other data and algorithms. Memory 702 may include any non-transitory computer-readable storage medium for storing data and/or software that is executable by processor 704, and/or any other medium which may be used to store information and which may be accessed by processor 704 to control the operation of computing device 701. Computing device 701 also may include or be in communication with a storage system 720 (e.g., repository, or other form of data storage separate from memory 702). In some examples, repository 720 may store a corpus of historical weather forecast data and potential analogs, as described herein.

Computing device 701 may further include a display 706, a network interface 708, an input device 710, and/or an output module 712. Display 706 may be any display device by means of which computing device 701 may output and/or display data, such as via GUI 718. Network interface 708 may be configured to connect to a network such as a local area network (LAN) including one or more of a wired network, a wireless network, a wide area network (WAN), a wireless mobile network, a Bluetooth network, a satellite network, and/or the internet. Input device 710 may be a mouse, keyboard, or other hand-held controller, touch screen, voice interface, and/or any other device or interface by means of which a user may interact with computing device 701. Output module 712 may be a bus, port, and/or other interface by means of which computing device 701 may connect to and/or output data to other devices and/or peripherals.

FIG. 7B is a simplified block diagram of an exemplary distributed computing system suitable for performing the methods described herein, in accordance with one or more embodiments. Distributed computing system 750 may include two or more computing devices 701a-n. In some examples, each of 701a-n may comprise one or more of processors 704a-n, respectively, and one or more of memory 702a-n, respectively. Processors 704a-n may function similarly to processor 704 in FIG. 7A, as described above. Memory 702a-n may function similarly to memory 702 in FIG. 7A, as described above.

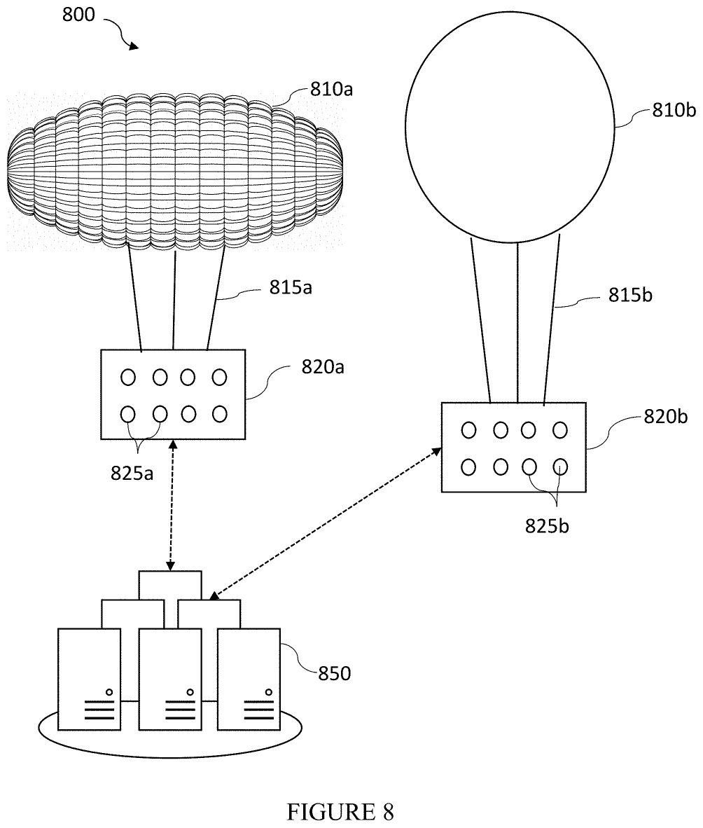

Schematic diagrams of an exemplary operational system in which wind forecasting methods may be implemented are shown in FIG. 8, in accordance with one or more embodiments. System 800 may include one or more aerial vehicles, for example balloons (e.g., superpressure, dirigible) 810a-b, carrying payloads 820a-b and various sensors 825, respectively. The one or more aerial vehicles may be in communication with a computing device 850 (e.g., with the same or similar components as computing systems 700 and 750, similarly numbered components functioning the same as, or similar to, each other). In some examples, the aerial vehicles may be wind-influenced or wind-driven aerial vehicle. In other examples, the aerial vehicles may be actively propelled.

Sensors 825a-b may include Global Positioning System (GPS) sensors, wind speed and direction sensors such as wind vanes and anemometers, temperature sensors such as thermometers and resistance temperature detectors (i.e., RTDs), speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors (e.g., a star tracker), and more. These examples of sensors are not intended to be limiting, and those skilled in the art will appreciate that other sensors or combinations of sensors in addition to these described may be included without departing from the scope of the present disclosure.

Payload 820a-b may comprise a controller, or other computing device or logic circuit configured to control components of the aerial vehicles. In an embodiment, payload 820a-b may be coupled to balloons 810a-b, respectively, using one or more down connects 815a-b. Payload 820a-b may include or be coupled to sensors 825a-b, respectively.

Computing device 850 may be configured to control operations of one or more components of payloads 820a-b and balloons 810a-b. Computing device 850 may be any computing device configurable for use in controlling and/or planning a flight path for aerial vehicles. For example, computing device 850 may comprise a desktop computer, laptop computer, tablet computer, smart phone, server and terminal configuration, datacenter, and/or any other computing device known to those skilled in the art. In one embodiment, computing device 850 comprises a datacenter or other control facility (e.g., configured to run a distributed computing system, as described herein), and may communicate with payloads 820a-b via a network. As described herein, system 800, and particularly computing device 850, may be used for planning a flight path or course for aerial vehicles based on wind forecasts, for example, to navigate aerial vehicles along a desired heading or to a target location.

In some examples, balloons 810a-b may carry and/or include other components that are not shown (e.g., altitude control system, propeller, fin, electrical and other wired connections, avionics chassis, onboard flight computer, ballonet, communications unit including transceivers, gimbals, and parabolic terminals). Those skilled in the art will recognize that the systems and methods disclosed herein may similarly apply and be usable by various other types of aerial vehicles.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

1. A distributed computing system for wind forecasting in a region of the atmosphere comprising:
an analog ensemble distilling architecture comprising:
a learner configured to train a deep neural network using analog ensemble data and output a distilled analog ensemble,
a reservoir comprising a cache,
a builder comprising a plurality of jobs configured to sample a plurality of slices of an analog ensemble function,
a corpus;
a processor configured to:
apply an analog ensemble operator,
generate overlapping forecast output files, and
generate wind forecasts; and
a memory configured to store one or more components of the analog ensemble distilling architecture,
wherein the distilled analog ensemble is configured to output an improved wind forecast.

2. The system of claim 1, further comprising a metalearner configured to vary a learning parameter.

3. The system of claim 2, wherein the learning parameter comprises a learning rate.

4. The system of claim 2, wherein the learning parameter comprises a batch size.

5. The system of claim 1, wherein the cache is an in-memory cache.

6. The system of claim 1, wherein the cache is distributed over a plurality of jobs.

7. The system of claim 1, wherein the corpus comprises a plurality of key-value pairs pairing a forecast with a ground truth observation.

8. The system of claim 7, wherein each of the plurality of key-value pairs indicates a latitude and a longitude.

9. The system of claim 7, wherein each of the plurality of key-value pairs indicates an altitude.

10. The system of claim 7, wherein each of the plurality of key-value pairs indicates a lead time.

11. The system of claim 1, wherein the improved wind forecast is deterministic.

12. The system of claim 1, wherein the improved wind forecast is probabilistic.

13. The system of claim 12, wherein the probabilistic improved wind forecast comprises a quantification of the ensemble mean uncertainty.

14. A method for distilling an analog ensemble, comprising:
receiving weather forecast data and weather observation data for a region of the atmosphere;
generating, by a distributed computing system, a corpus comprising a forecast-observation key-value pair for each point on a grid map, each point indication a location on the grid map;
generating an in-memory cache comprising an evolving plurality of training examples, each training example comprising a slice of an analog ensemble;
training a deep neural network using the evolving plurality of training examples; and
outputting a distilled analog ensemble.

15. The method of claim 14, further comprising saving the corpus as a data file.

16. The method of claim 14, wherein generating the corpus comprises generating a set of forecast outputs comprising a plurality of forecast outputs that are overlapping in time, the set of forecast outputs based on the weather forecast data.

17. The method of claim 14, wherein the corpus represents historical forecast and observation data spanning at least two years.

18. Method for generating an improved wind forecast in a region of the atmosphere, comprising:
receiving a forecast comprising a wind vector for a plurality of grid points on a grid map;
applying a distilled analog ensemble at all grid points of the forecast; and
outputting an improved forecast.

19. The method of claim 18, wherein the distilled analog ensemble uses inputs of one, or a combination of two or more, of a latitude, a longitude, a pressure, and a lead time.

20. The method of claim 18, wherein the improved forecast has a lower error rate than the forecast.

21. The method of claim 18, wherein the improved forecast provides an uncertainty quantification.
